(19) United States
(12) Patent Application Publication
(10) Pub. No.: US 2025/0298835 A1
(43) Pub. Date: Sep. 25, 2025

(54) Methods And Systems For Personalized Transcript Searching And Indexing Of Online Multimedia

(71) Applicant: Jayeshkumar Mahajan, Arlington, MA (US)

(72) Inventor: Jayeshkumar Mahajan, Arlington, MA (US)

(73) Assignee: Tubertdata LLC, Casper, WY (US)

(21) Appl. No.: 18/609,465

(22) Filed: Mar. 19, 2024

(51) Int. Cl. G06F 16/435; G06F 16/41; G06F 16/438; G06F 16/483

(52) U.S. Cl. CPC G06F 16/435; G06F 16/41; G06F 16/438; G06F 16/483

(57) ABSTRACT

Methods and systems for personalized indexing and searching online media by spoken word content are disclosed. Some embodiments may include: receiving, at one or more servers, media files and corresponding transcripts, indexing, via the one or more servers, the transcript text in correlation with the associated media files, hosted locations, and aligned timecodes for textual transcript occurrences, accepting, via search interfaces communicatively coupled with the one or more servers, user text search queries to search the indexed transcript text, matching the user text search queries with specific media files and timestamps where matching spoken words and phrases are located, based on the indexed transcript text and returning search results to users, the search results including links to media files where matches occur and direct playback links, the direct playback links embedded with timestamps to commence playbacking from times where search term instances being spoken in the media files.

### FIELD OF THE DISCLOSURE

The present disclosure relates to the field of multimedia search and retrieval systems. Specifically, it pertains to methods and systems for personalized indexing and searching the spoken content in any language within audio and video files using natural language processing techniques, enabling users to locate and access specific segments of interest within large multimedia repositories through text-based queries and time-aligned search results.

### BACKGROUND

In recent years, the proliferation of online multimedia content has revolutionized the way people consume information and entertainment. Video sharing platforms, podcasts, and streaming services have become ubiquitous, offering users an unprecedented amount of content to choose from. However, this abundance of content has also brought forth significant challenges in terms of discoverability and accessibility.

One of the primary issues faced by users is the difficulty in finding specific information within large multimedia files in a targeted and specialized manner. While traditional search engines have made it easy to locate relevant web pages and documents based on text queries, searching within audio and video content remains a challenge. Users often have to manually scrub through lengthy recordings to find the specific segments they are interested in, leading to a time-consuming and frustrating experience.

Moreover, the lack of efficient search capabilities within multimedia content limits the potential for knowledge sharing and information dissemination. Valuable insights, educational content, and creative expressions embedded within audio and video files remain largely untapped due to the inability to quickly locate and access relevant segments in targeted personalized way. Further, similar-looking thumbnails make it difficult to locate specific locations in the video.

The industry has recognized these challenges and the opportunities they present. There is a growing demand for solutions that can bridge the gap between the vast amounts of multimedia content available and the users' need for quick and accurate access to specific information within these files. Advancements in artificial intelligence, machine leaming, and natural language processing have opened new possibilities for automatically transcribing and indexing audio and video content, making it searchable and more accessible.

Trends in the industry indicate a shift and need towards the development of intelligent media platforms that can understand and organize multimedia content at a granular level. By leveraging technologies such as speech recognition, text analysis, and time-aligned indexing, these platforms aim to enable users to search within audio and video files as easily as they would search through text documents to specific timestamps in a video.

The objective of the current invention is to address the challenges faced in searching and accessing specific information within multimedia content by providing a comprehensive solution that combines advanced personalized indexing, transcription, and search capabilities. The proposed system aims to empower users to quickly locate and access relevant segments within audio and video files, unlocking the full potential of multimedia content for leaming, entertainment, and knowledge sharing.

### SUMMARY

One aspect of the present disclosure relates to a method for indexing and searching online media by spoken word content. The method may include receiving, at one or more servers, media files and corresponding transcripts. The transcripts comprise text aligned with time-coded instances indicating where each word or phrase occurs in the associated media files. The method may include indexing; via one or more servers, the transcript text in correlation with the associated media files, hosted locations, and aligned timecodes for textual transcript occurrences. The method may include accepting, via search interfaces communicatively coupled with the one or more servers, user text search queries to search the indexed transcript text of any language in pronounceable format. The method may include matching the user text search queries with specific media files and timestamps where matching spoken words and phrases are located, based on the indexed transcript text in user consumed media content. The method may include returning search results to users, the search results including links to media files where matches occur and direct playback links, the direct playback links embedded with timestamps to commence play backing from times where search term instances being spoken in the media files.

Another aspect of the present disclosure relates to a system for indexing and searching online media by spoken word content. The system may include one or more hardware processors configured by machine-readable instructions for indexing and searching online media by spoken word content. The machine-readable instructions may be configured to receive, at one or more servers, media files and corresponding transcripts. The transcripts comprise text aligned with time-coded instances indicating where each word or phrase occurs in the associated media files. The machine-readable instructions may be configured to index, via the one or more servers, the transcript text in correlation with the associated media files, hosted locations, and aligned timecodes for textual transcript occurrences. The machine-readable instructions may be configured to accept, via search interfaces communicatively coupled with the one or more servers, user text search queries to search the indexed transcript text. The machine-readable instructions may be configured to match the user text search queries with specific media files and timestamps where matching spoken words and phrases are located, based on the indexed transcript text. The machine-readable instructions may be configured to return search results to users, the search results including links to media files where matches occur and direct playback links, the direct playback links embedded with timestamps to commence playback from times where search term instances be spoken in the media files.

### BRIEF DESCRIPTION OF THE DRAWINGS

FIG. 1 illustrates a system configured for indexing and searching online media by spoken word content.

FIG. 2A illustrates a method for indexing and searching online media by spoken word content.

FIG. 2B is a continuation of the method of FIG. 2A according to one aspect.

FIG. 2C is an exemplary method according to another aspect.

FIG. 2D is an exemplary method according to another aspect.

FIG. 2E is an exemplary method according to another aspect.

FIG. 2F is an exemplary method according to another aspect.

FIG. 2G is an exemplary method according to another aspect.

FIG. 2H is an exemplary method according to another aspect.

FIG. 2I is an exemplary method according to another aspect.

FIG. 2J is an exemplary method according to another aspect.

FIG. 2K is an exemplary method according to another aspect.

FIG. 2L is an exemplary method according to another aspect.

FIG. 2M is an exemplary method according to another aspect.

### DETAILED DESCRIPTION

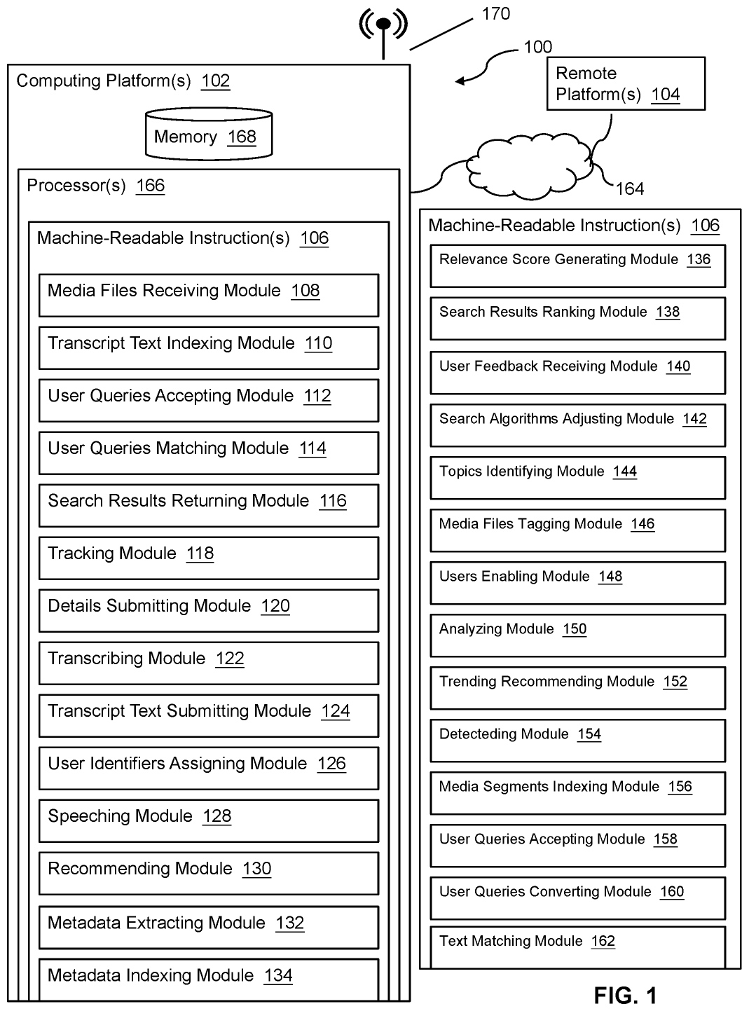

FIG. 1 illustrates a system configured for indexing and searching online media by spoken word content, in accordance with one or more embodiments. In some cases, system 100 may include one or more computing platforms 102. The one or more remote computing platforms 102 may be communicably coupled with one or more remote platforms 104. In some cases, users may access system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of media files receiving module 108, transcript text indexing module 110, user queries accepting module 112, user queries matching module 114, search results returning module 116, tracking module 118, details submitting module 120, transcribing module 122, transcript text submitting module 124, user identifiers assigning module 126, speeching module 128, recommending module 130, metadata extracting module 132, metadata indexing module 134, relevance score generating module 136; search results ranking module 138, user feedback receiving module 140, search algorithms adjusting module 142, topics identifying module 144, media files tagging module 146, users enabling module 148, analyzing module 150, trending recommending module 152, Detecting module 154, media segments indexing module 156, user queries accepting module 158, user queries converting module 160, text matching module 162, and/or other modules.

Media files receiving module 108 may be configured to receive, at one or more servers, media files and corresponding transcripts. The transcripts comprise text aligned with time-coded instances indicating where each word or phrase occurs in the associated media files. Transcript text indexing module 110 may be configured to index, via the one or more servers, the transcript text in correlation with the associated media files, hosted locations, and aligned timecodes for textual transcript occurrences. User queries accepting module 112 may be configured to accept, via search interfaces communicatively coupled with the one or more servers, user text search queries to search the indexed transcript text. User queries matching module 114 may be configured to match the user text search queries with specific media files and timestamps (which may be based on specific media consumed by a user over a predefined period) where matching spoken words and phrases are located, based on the indexed transcript text. Search results retuming module 116 may be configured to retum search results to users, the search results including links to media files where matches occur and direct playback links, the direct playback links embedded with timestamps to commence playback from times where search term instances be spoken in the media files.

Tracking module 118 may be configured to track media files accessed by users during web browsing sessions, via a client application installed on user devices. Details submitting module 120 may be configured to submit details and recordings of the tracked media files.

Transcribing module 122 may be configured to locally transcribe speech from the recordings of the tracked media files into machine-readable transcript text. Transcript text submitting module 124 may be configured to submit the machine-readable transcript text to the one or more servers for indexing.

User identifiers assigning module 126 may be configured to assign unique user identifiers to group together media access history and contributions from individual users.

Speeching module 128 may be configured to phonetically interpreting speech from audio tracks to generate pronounceable transcript text that is searchable based on pronunciation for languages unsupported by automated speech recognition.

Recommending module 130 may be configured to recommend additional media items determined to be relevant based on browsing histories associated with the unique user identifiers of other users having similar media access patterns.

In some cases, the direct playback links point playback to spots temporally preceding matched search term instances by an amount of time dynamically determined based on a density of nearby transcript text, to provide context for the matched search term instances.

Metadata extracting module 132 may be configured to extract available metadata associated with the media files. Metadata indexing module 134 may be configured to index the extracted metadata in association with the media files and the transcript text.

Relevance score generating module 136 may be configured to generate a relevance score for each media file based on the frequency and distribution of the user text search query terms within the indexed transcript text associated with the media file. Search results ranking module 138 may be configured to rank the search results based on the relevance scores of the media files.

User feedback receiving module 140 may be configured to receive user feedback indicating relevance of returned search results. Search algorithms adjusting module 142 may be configured to adjust search algorithms based on the user feedback to improve future search result relevance.

Topics identifying module 144 may be configured to identify key topics and entities within the indexed transcript text using natural language processing techniques. Media files tagging module 146 may be configured to tag the media files with the identified key topics and entities. Users enabling module 148 may be configured to enable users to filter and refine search results based on the key topics and entities.

Analyzing module 150 may be configured to analyze media access patterns across unique user identifiers to identify trending topics and popular media content. Trending recommending module 152 may be configured to recommend trending and popular media content to users based on the analyzing.

Detecting module 154 may be configured to segment the media files into shorter segments based on topic shifts detected within the transcript text. Media segments indexing module 156 may be configured to index the media segments separately to enable more granular search results pointing to specific segments within longer media files.

User queries accepting module 158 may be configured to accept user queries in spoken form. User queries converting module 160 may be configured to convert the spoken user queries to text using automated speech recognition. Text matching module 162 may be configured to match the converted text with the indexed transcript text to generate search results.

In some cases, the one or more computing platforms 102, may be communicatively coupled to the remote platform(s) 104. In some cases, the communicative coupling may include communicative coupling through a networked environment 164. The networked environment 164 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platform(s) 104 may be operatively linked via some other communication coupling. The one or more one or more computing platforms 102 may be configured to communicate with the networked environment 164 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IOT) devices, or other mobile or stationary devices. In an embodiment, system 100 may also include one or more hosts or servers, such as the one or more remote platforms 104 connected to the networked environment 164 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 166 for processing information and executing instructions or operations. One or more processors 166 may be any type of general or specific purpose processor. In some cases, multiple processors 166 may be utilized according to other embodiments. In fact, the one or more processors 166 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, one or more processors 166 may be remote from the one or more computing platforms 102, such as disposed within a remote platform like the one or more remote platforms 166 of FIG. 1.

The one or more processors 166 may perform functions associated with the operation of system 100 which may include, for example, precoding of antenna gain/phase parameters, encoding and decoding of individual bits forming a communication message, formatting of information, and overall control of the one or more computing platforms 102, including processes related to management of communication resources.

The one or more computing platforms 102 may further include or be coupled to a memory 168 (internal or external), which may be coupled to one or more processors 166, for storing information and instructions that may be executed by one or more processors 166. Memory 168 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 168 can consist of any combination of random access memory (RAM), read only memory (ROM), static storage such as a magnetic or optical disk, hard disk drive (HDD), or any other type of non-transitory machine or computer readable media. The instructions stored in memory 168 may include program instructions or computer program code that, when executed by one or more processors 166, enable the one or more computing platforms 102 to perform tasks as described herein.

In some embodiments, one or more computing platforms 102 may also include or be coupled to one or more antennas 170 for transmitting and receiving signals and/or data to and from one or more computing platforms 102. The one or more antennas 170 may be configured to communicate via, for example, a plurality of radio interfaces that may be coupled to the one or more antennas 170. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more dowalinks and to receive symbols (for example, via an uplink).

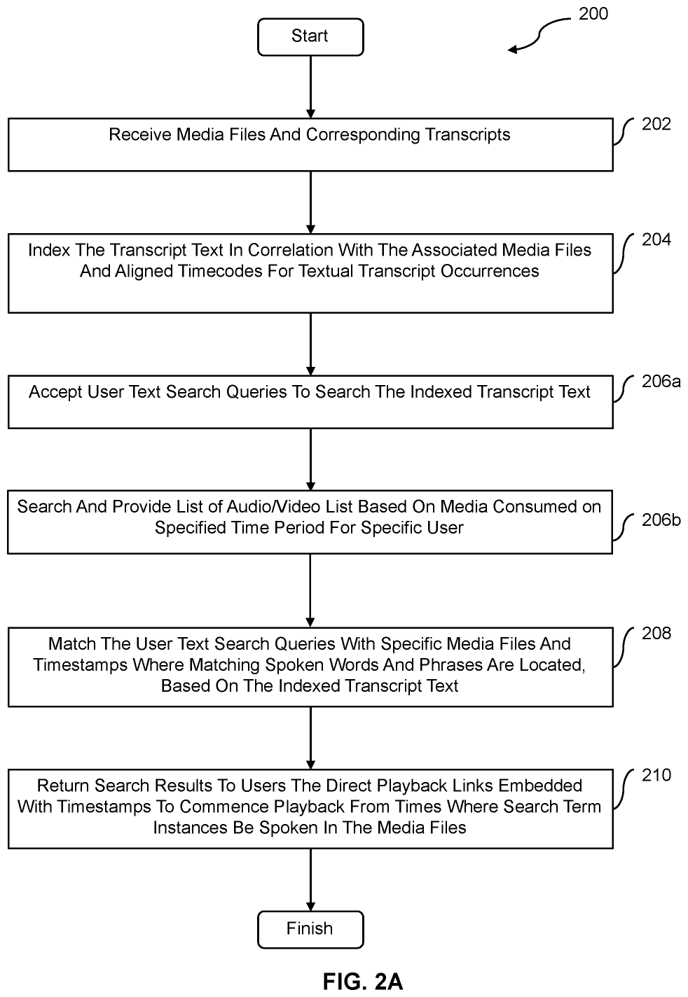

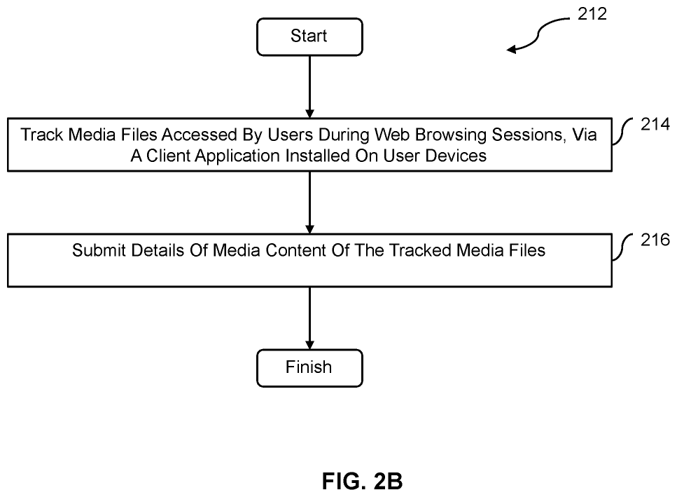

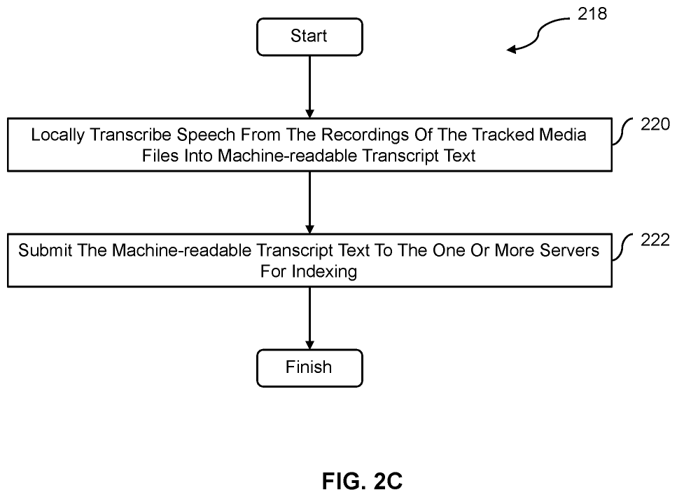

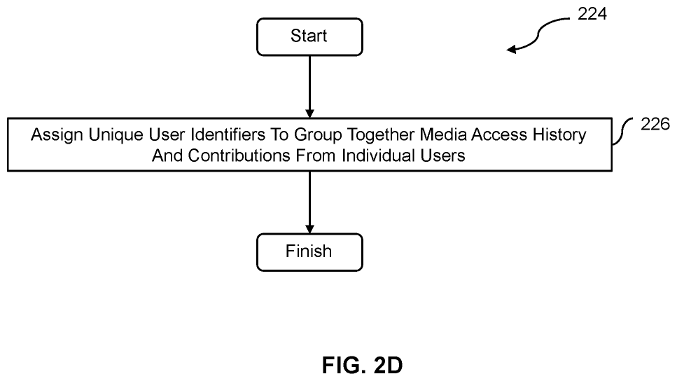

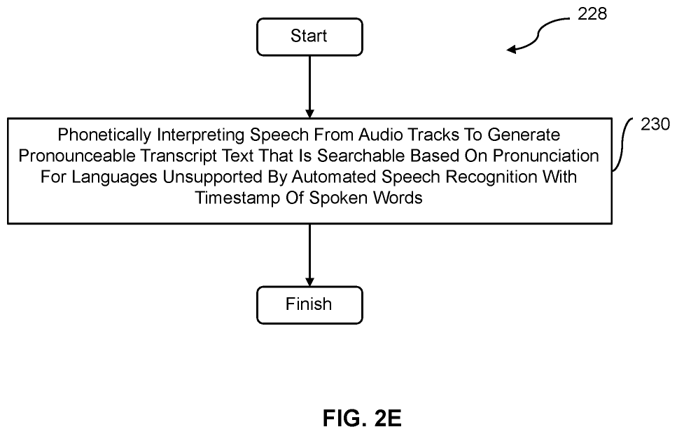

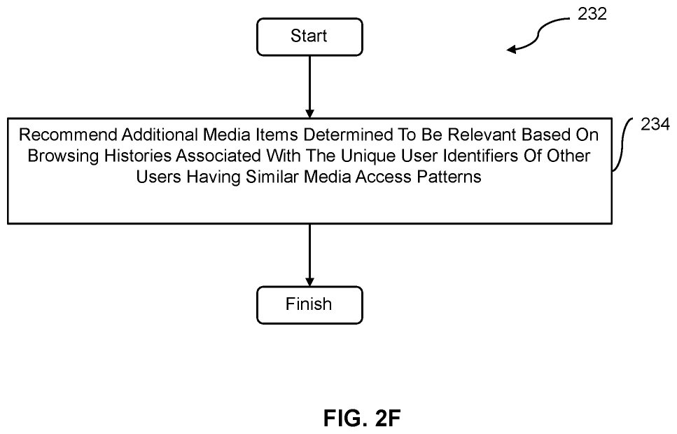

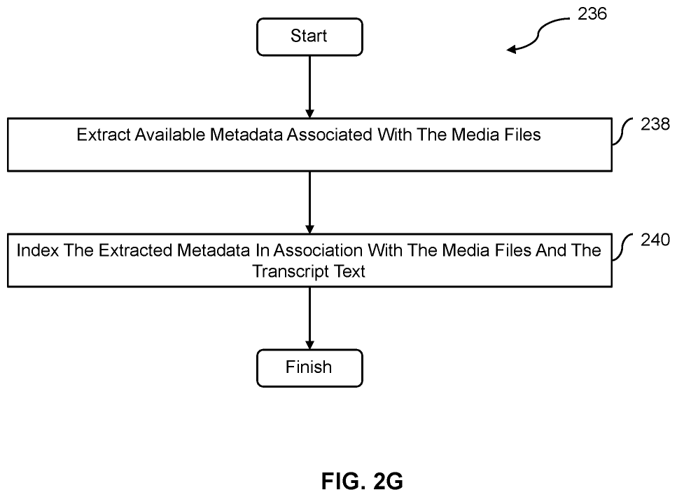

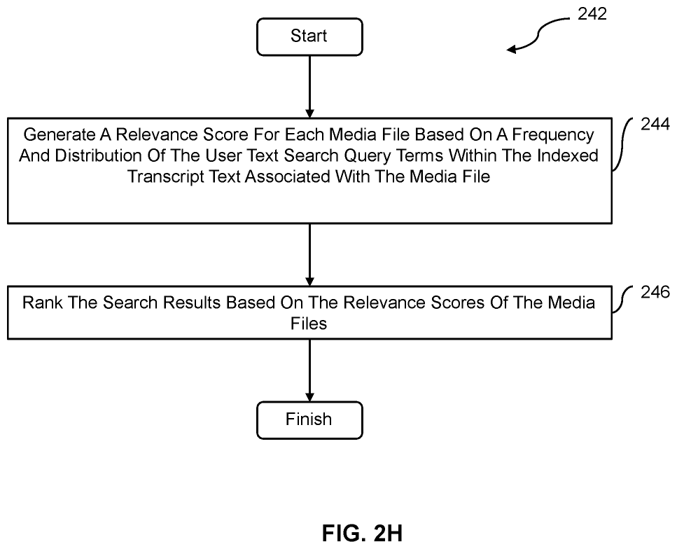

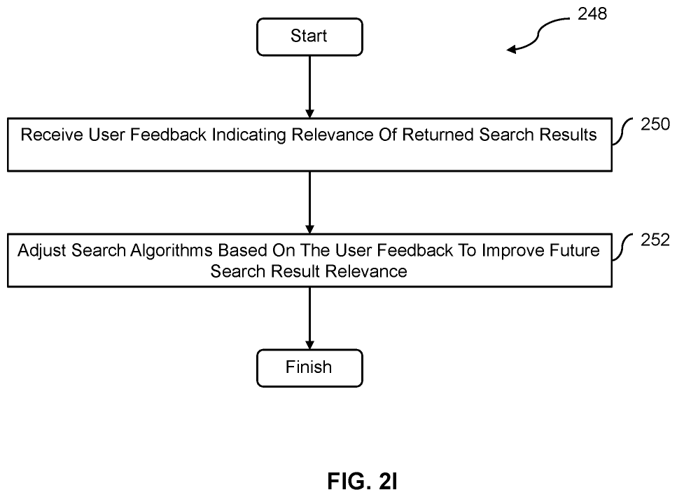

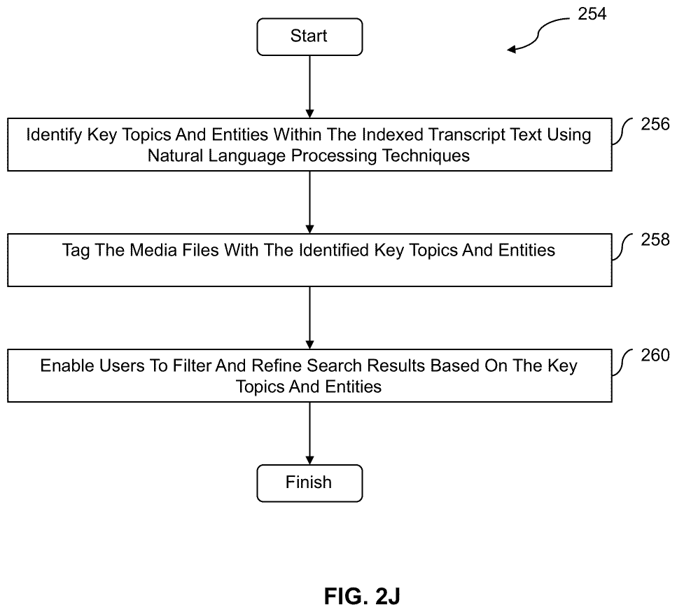

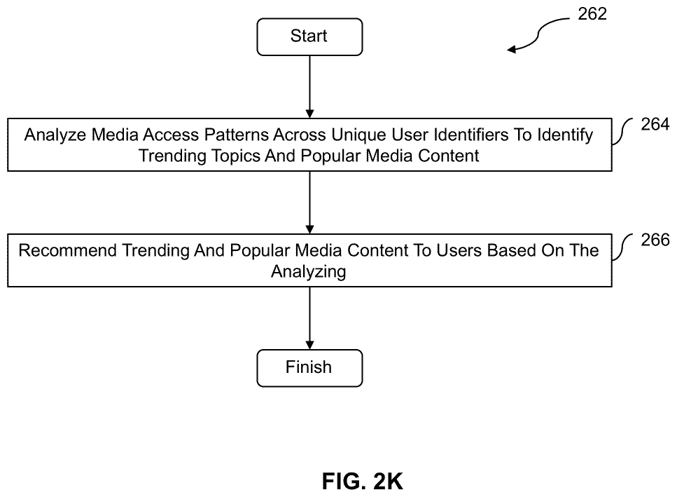

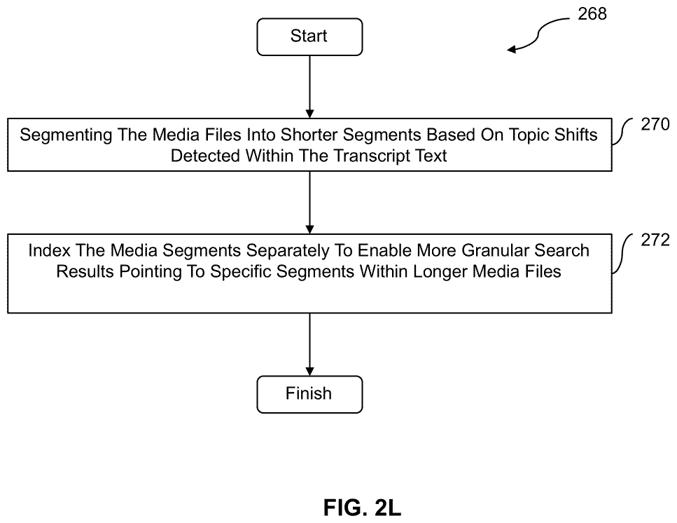

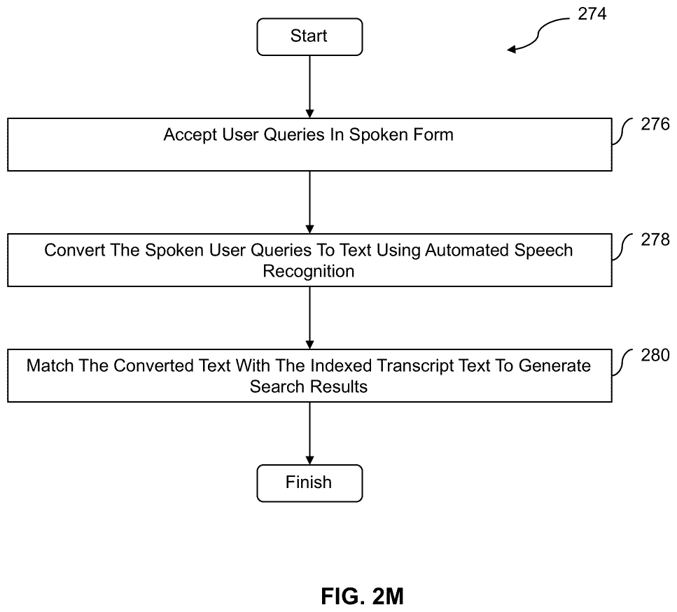

FIGS. 2A, 2B, 2C, 2D, 2E, 2F, 2G, 2H, 2I, 2J, 2K, 2L and/or 2M illustrate an example flow diagram of a method 200, according to one embodiment. The method 200 may include receiving, at one or more servers, media files and corresponding transcripts at block 202, the transcripts comprise text aligned with time-coded instances indicating where each word or phrase occurs in the associated media files. The method 200 may include indexing, via one or more servers, the transcript text in correlation with the associated media files, hosted locations, and aligned timecodes for textual transcript occurrences at block 204. The method 200 may include accepting, via search interfaces communicatively coupled with one or more servers, user text search queries to search the indexed transcript text at block 206. The method 200 may include matching the user text search queries with specific media files and timestamps associated with personalized user media consumption where matching spoken words and phrases are located, based on the indexed transcript text at block 208. The method 200 may include returning search results to users, the search results including links to media files where matches occur and direct playback links, the direct playback links embedded with timestamps to commence play backing from times where search term instances being spoken in the media files at block 210.

In FIG. 2B, method 200 may be continued at 212, and may further include tracking media files accessed by users during web browsing sessions, via a client application installed on user devices at block 214. The method 200 continued at 212 may also further include submitting details such as the timestamps of the tracked media files at block 216.

In FIG. 2C, the method 200 may be continued at 218, and may further include transcribing speech from the recordings of the tracked media files into machine-readable transcript text at block 220. The method 200 continued at 218 may also further include submitting the machine-readable transcript text to the one or more servers for indexing by a server at block 222.

In FIG. 2D, the method 200 may be continued at 224, and may further include assigning unique user identifiers to group together media access history and contributions from individual users at block 226.

In FIG. 2E, the method 200 may be continued at 228, and may further include phonetically interpreting speech from audio tracks to generate pronounceable transcript text with a timestamp of spoken words that is searchable based on pronunciation for languages unsupported by automated speech recognition at block 230.

In FIG. 2F, the method 200 may be continued at 232, and may further include recommending additional media items determined to be relevant based on browsing histories associated with the unique user identifiers of other users having similar media access patterns at block 234.

In FIG. 2G, the method 200 may be continued at 236, and may further include extracting available metadata associated with the media files at block 238. The method 200 continued at 236 may also further include indexing the extracted metadata in association with the media files and the transcript text at block 240.

In FIG. 2H, the method 200 may be continued at 242, and may further include generating a relevance score for each media file based on a frequency and distribution of the user text search query terms within the indexed transcript text associated with the media file at block 244. The method 200 continued at 242 may also further include ranking the search results based on the relevance scores of the media files at block 246.

In FIG. 21, the method 200 may be continued at 248, and may further include receiving user feedback indicating relevance of returned search results at block 250. The method 200 continued at 248 may also further include adjusting search algorithms based on the user feedback to improve future search result relevance at block 252.

In FIG. 2J, the method 200 may be continued at 254, and may further include identifying key topics and entities within the indexed transcript text using natural language processing techniques at block 256. The method 200 continued at 254 may further include tagging the media files with the identified key topics and entities at block 258. The method 200 continued at 254 may also further include enabling users to filter and refine search results based on the key topics and entities at block 260.

In FIG. 2K, the method 200 may be continued at 262, and may further include analyzing media access patterns across unique user identifiers to identify trending topics and popular media content at block 264. The method 200 continued at 262 may also further include recommending trending and popular media content to users based on the analyzing at block 266.

In FIG. 2L, the method 200 may be continued at 268, and may further include. segmenting the media files into shorter segments based on topic shifts detected within the transcript text at block 270. The method 200 continued at 268 may also further include indexing the media segments separately to enable more granular search results pointing to specific segments within longer media files at block 272.

In FIG. 2M, the method 200 may be continued at 274, and may further include accepting user queries in spoken form at block 276. The method 200 continued at 274 may further include converting the spoken user queries to text using automated speech recognition at block 278. The method 200 continued at 274 may also further include matching the converted text with the indexed transcript text to generate search results at block 280.

In some cases, the method 200 may be performed by one or more hardware processors, such as the processors 166 of FIG. 1, configured by machine-readable instructions, such as the machine-readable instructions 106 of FIG. 1. In this aspect, the method 200 may be configured to be implemented by the modules, such as the modules 108, 110, 112, 114, 116, 118, 120, 122, 124, 126, 128, 130, 132, 134, 136, 138, 140, 142, 144, 146, 148, 150, 152, 154, 156, 158, 160 and/or 162 discussed above in FIG. 1.

In preferred aspects, the disclosed system comprises a browser extension that integrates with web browsers to index multimedia content by spoken words and their corresponding timestamps. The browser extension passively tracks a user's web media consumption within the browser, detecting when audio or video content is streamed preferably via a URL or some other implement. This includes media from sites like YouTube, TikTok, news sites, etc. The extension may transmit tracked media consumption to a server that maintains an index database connecting words and phrases to the videos and audio files in which they are spoken. This index is. continually updated as users consume more media. For media with existing transcripts available, the extension or the server may extract the transcript text and identifies the corresponding timestamp for each word. This allows mapping words to the specific minute/second they are spoken. For media without transcripts, the server or the extension having a transcription algorithm thereon may utilize speech recognition to automatically generate a transcript. It converts the audio track to text and, using the generated transcript, determines timestamps for each recognized word. The database index supports search queries-users can supply words/phrases to fetch media segments where those exact terms are spoken, along with direct access links with embedded timestamps pointing to matched spots.

In some aspects, the media index database employs a structured data schema optimized for text search query purposes and to deliver direct access links to matching video segments. As an example, the core schema comprises:

Video IDs unique to each indexed video file and the source platform.

Transcript texts associated with each video ID. Transcripts may be pre-existing or automatically generated via speech recognition.

Alignments that map each line/sentence in the transcript text to its corresponding video ID and the starttend timestamps where it is spoken. As an example, timestamps may have up to 5 second precision, although other arrangements may suffice.
For example:
Video: YouTube_1234
Line: “We talked to researchers to learn more about recent discoveries.”
Alignment: YouTube_1234, 00:05:10-00:05:15

With this structure, the transcript texts become searchable-when users search for phrases, the system matches the search terms to lines in the transcripts associated to stored videos. Via the alignments of those matching lines, it is able to then pinpoint locations in the video recording where those exact search phrases occur. It returns both the video access links, as well as direct URL links with embedded timestamps pointing users to the relevant matching sections. Optionally, variable precision timestamp alignments can dynamically link search phrases to segments of different durations (5 sec, 10 sec etc.) within media to account for context.

In preferred aspects, the system includes a web-based graphical interface to allow user search queries across the indexed media database. This front-end provides the entry point to discover videos and audio by matching search terms to speech within multimedia transcripts. The web interface displays a search box where users can enter query text-words, phrases, or natural language questions. This connects via API to a back-end server hosting the time-aligned transcript database.

When the user enters a search phrase, the interface sends this as a string to the server via an API for the server to scan across video/audio transcripts andtheir word alignments for matching entries, and receive a list of watched media items over a specified time period. The back-end search logic matches input query text to indexed transcripts and retrieves video IDs and timestamp alignments for the most relevant matches where that phrase is spoken. These search results, comprising links to matching videos and direct access links with embedded timestamps, are sent back to the web interface formatted in the appropriate front-end code (HTML, etc). The web UI displays the matching videos and highlights the search query text within the transcript excerpts. Critically, it shows playable access links pointing users directly to the spot where the search phrase match was uttered within each media file.

What is claimed is:

1. A method for indexing and searching online media by spoken word content, the method comprising:
receiving, at one or more servers, a list of watched media items over a specified time period;
receiving, at the one or more servers, media files and corresponding transcripts, wherein the transcripts comprise text aligned with time-coded instances indicating where each word or phrase occurs in the associated media files;
indexing, via the one or more servers, the transcript text in correlation with the associated media files, hosted locations, and aligned timecodes for textual transcript occurrences;
accepting, via search interfaces communicatively coupled with the one or more servers, user text search queries to search the indexed transcript text,
matching the user text search queries with specific media files and timestamps where matching spoken words and phrases are located, based on the indexed transcript text, and
returning search results to users, the search results including links to media files where matches occur and direct playback links, the direct playback links embedded with timestamps to commence playback from times where search term instances are spoken in the media files.

2. The method of claim 1, further comprising: tracking media files accessed by users during web browsing sessions, via a client application installed on user devices; submitting, to the one or more servers for indexing, details and recordings of the tracked media files.

3. The method of claim 2, further comprising:
transcribing, speech from the recordings of the tracked media files into machine-readable transcript text; and
submitting the machine-readable transcript text to the one or more servers for indexing.

4. The method of claim 2, further comprising: assigning unique user identifiers to group together media access history and contributions from individual users, wherein the unique user identifiers are not connected to user identities.

5. The method of claim 1, further comprising: phonetically interpreting speech from audio tracks to generate pronounceable transcript text that is searchable based on pronunciation for languages unsupported by automated speech recognition.

6. The method of claim 4, further comprising: recommending, to individual users, additional media items determined to be relevant based on browsing histories associated with the unique user identifiers of other users having similar media access patterns.

7. The method of claim 1, wherein the direct playback links point playback to spots temporally preceding matched search term instances by an amount of time dynamically determined based on a density of nearby transcript text, to provide context for the matched search term instances.

8. The method of claim 1, further comprising: extracting, via the one or more servers, available metadata associated with the media files; indexing the extracted metadata in association with the media files and the transcript text.

9. The method of claim 1, further comprising: generating, via the one or more servers, a relevance score for each media file based on a frequency and distribution of the user text search query terms within the indexed transcript text associated with the media file; ranking the search results based on the relevance scores of the media files.

10. The method of claim 1, further comprising: receiving, via the search interfaces, user feedback indicating relevance of returned search results; adjusting, via the one or more servers, search algorithms based on the user feedback to improve future search result relevance.

11. A computer program product comprising a non-transitory computer readable medium storing instructions which when executed by one or more processors of a server system causes the server system to:
receive multimedia files and associated text transcripts with time alignments between the transcript text words and phrases and timestamps of matching spoken instances within the multimedia;
index received transcript texts, multimedia identifiers, and timestamps indicating where every transcript segment occurs in the linked multimedia;
accept text-based search queries from remote user devices;
receive a list of watched media items over a specified time period;
match search queries with locations in indexed transcripts linked to multimedia files and timecodes where they are spoken; and
return search results to the user devices comprising links to relevant multimedia files and direct access links with embedded timestamps pointing to times where the search terms are uttered.

12. The computer program product of claim 11 wherein the instructions further cause the server system to:
track media accessed by individual users during web browsing sessions and submit details of browsed media to the server system, via a client software component installed in the user devices;
locally process audio recordings of the browsed media to generate searchable transcripts, via the client software component; and
associate submissions and contributions from identifiable individual users, without directly identifying the users, based on assigned unique user identifiers, to facilitate personalization of search experiences.

13. The computer program product of claim 11, wherein the instructions further cause the server system to update the indexed media transcripts and associated timestamps on an ongoing basis as new multimedia files and transcripts are received.

14. The computer program product of claim 12, wherein the client software component passively indexes and tracks media accessed by user devices without requiring user input by continuously monitoring the URLs of media played during browsing sessions.

15. The computer program product of claim 12, wherein the client software component further. extracts available metadata embedded in or associated with media files played on the user devices during browsing sessions and submits extracted metadata to the server system for indexing.

16. The computer program product of claim 11, wherein for audio tracks in languages unsupported by automated speech recognition, the instructions further cause the server system to:
phoneticize non-readable transcript characters; and
index phonetically-interpreted transcript text to enable text searchability based on pronunciation where semantic meaning cannot be extracted.

17. The computer program product of claim 12, wherein the instructions further cause the server system to personalize search results for individual user identifiers by weighting higher in search relevance metrics:
media items submitted and indexed from that specific user's media browsing history; and
media items indexed as accessed by a significant proportion of other users with contextual commonalities to the user identifier.
